(19) United States
(12) Patent Application Publication
(10) Pub. No.: US 2006/0056906 A1
(43) Pub. Date: Mar. 16, 2006

(54) Ring binder mechanism

(76) Inventor: Hans Johann Horn, Bern (CH)

Correspondence Address: PENDORF & CUTLIFF, 5111 MEMORIAL HIGHWAY, TAMPA, FL, 33634-7356, US

(21) Appl. No.: 10/542,731

(22) PCT Filed: Jan. 17, 2004
(86) PCT No.: PCT/EP04/00329

§ 371 Date: Jul. 20, 2005

(30) Foreign Application Priority Data
Jan. 24, 2003 (CH) 2003-0098/03

(51) Int. Cl. B42F 13/20

(52) U.S. Cl. 402/31

(57) ABSTRACT

The invention relates to a ring binder mechanism for housing perforated documents. The ring binder mechanism comprises a housing (10) with spring elastically flexible housing flanks (28). Two carrier rails (20) are arranged within the housing (10), which may be pivoted towards each other by the spring action of the housing flanks (28) in the manner of an elbow joint in the region of the longitudinal edges thereof which face each other. At least two half rings (16), which pair-wise form a ring (14), are rigidly connected to the support rails (20) at defined longitudinal separations from each other. At least two locking elements (32), operated by means of an actuating element (18) and a tie rod (44), are further provided, which engage in a free space (34), formed between the carrier rails (20) and a housing wall (13), in the locked position, with locking of the pivoting movement of the carrier rails (20) and which release the pivoting path about the joint axis (22) in the opened state, whereby the locking elements (32) are pre-tensioned in the closing direction by the action of a closing spring (36). According to the invention, only one single tie rod (44) is provided, the tie rod comprising several dogs (201), each of which is provided for cooperating with one of the locking elements (32).

### BACKGROUND OF THE INVENTION

1. Field of the Invention

The invention concerns a ring binder mechanism with a housing having a C-shaped or U-shaped cross-section, with elastic mounting flanks which can be bent open for receiving two carrier rails, of which the inward facing longitudinal edges lie against each other forming a linkage axis, and of which the outward facing longitudinal edges engage in mounting grooves of the mounting flanks, and with at least two half-rings rigidly connected with the carrier rail in a defined longitudinal separation from each other, extending through openings in a housing wall and pairwise forming themselves into a ring, wherein the carrier rails, taking along the half rings, are limitedly pivotable relative to each other about the longitudinal pivot axis between an open position and a closed position while overcoming the spring force produced by the bending open of the mounting flanks, and wherein at least two locking elements are provided, activatable via an operating element and a tie rod, which when in the locked position engage in a free space formed between the carrier rails and the housing wall thereby blocking the pivot movement of the carrier rails, and when in the open position free the linkage axis to pivot, wherein the locking elements are pre-tensioned in the closed direction by a locking spring.

2. Related Art of the Invention

A ring binder mechanism of this type is known (WO 01/81099), in which each locking element is provided with a tie rod associated with the actuating element, each tie rod having an integrated locking spring. The tie rod must accordingly be made of a springy material. Further to be considered is that, in the known ring binder mechanisms, in practical embodiments with more than two rings, these are provided however with only two locking elements. The use of more than two locking elements is desirable, for example, in mechanisms with three or more rings, but this is neither disclosed nor enabled.

Beginning therewith, it is the task of the present invention to improve the ring binder mechanism of the type described in the introductory section in such a manner that more than two locking elements can be employed.

### SUMMARY OF THE INVENTION

For solving this task, the characteristics set forth in Patent Claim 1 are proposed. Advantageous embodiments and further developments of the invention can be seen from the dependent claims.

The inventive solution is comprised essentially therein, that the tie rod includes multiple dogs (or catches or engagement elements or bends), each of which is respectively associated with one locking element.

In accordance with a preferred embodiment of the invention, the tie rod is comprised of a piece of wire extending essentially parallel to the linkage axes, wherein the dogs are bends or offsets on the tie rod.

Each locking element is preferably, provided with its own locking spring, independent from the tie rod, wherein the locking spring may be in the form of a leg spring. For simplification of assembly, it is basically also possible, that only one locking spring is provided, engaging the end of the tie rod opposite to the actuating element.

According to a further preferred embodiment of the invention, each locking element includes a receptacle for one of the dogs of the tie rod, via which it is in operative association therewith.

A further preferred embodiment of the invention envisions that at least one of the locking elements is a pivot element, wherein the at least one locking element is held pivotable on one of the two carrier rails and/or on the housing.

A ring binder mechanism with four rings can accordingly be equipped with four locking elements, wherein the locking elements are mounted pivotably upon one of the two carrier rails and each locking element can be associated with a locking spring in the form of a leg spring. The locking elements can be provided with wedge-shaped locking surfaces, which cooperate or engage with the carrier rails in the locked position. By the individual spring pressure of the locking elements in the closing direction, it is advantageously achieved, that each locking element in the closed position exercises an optimal closing force upon the carrier rails, which creates a high holding force on the rings.

When using only one locking spring on the end of the tie rod opposite to the actuating element, the receptacles on the locking elements for the dogs of the tie rod must be so designed, that the pivotable ring elements can be pivoted by the dogs both in the opening direction as well as in the closing direction.

### BRIEF DESCRIPTION OF THE DRAWINGS

In the following, the invention will be described in greater detail on the basis of the embodiment shown in the figures. There is shown:

FIG. 1a-c a side view, a top view and an end view of a ring binder mechanism with four rings in closed position;

FIG. 2a-c a bottom view of the ring binder mechanism, an enlarged section of FIG. 2a and a section along line A-A of FIG. 2a;

FIGS. 3a and b a perspective representation of the ring binder mechanism from above and from below without housing;

FIGS. 3c and d respectively an enlarged section in the area of the third ring of FIGS. 3a and b;

FIG. 4a a perspective representation of the locking element in the form of a pivot element;

FIG. 4b a section of the tie rod in the area of a dog in perspective representation;

FIG. 4c a perspective representation of a section of the two carrier rails in the area of a ring in closed position;

FIG. 5a a side view of the elements in operative engagement: operating element, tie rod and locking elements;

FIG. 5b-c a top view and a side view of the tie rod;

FIG. 6a-b two sectional representations of the ring binder mechanism according to FIG. 2a in first and second phases of opening;

FIG. 7a-b a perspective representation of the ring binder mechanism in open position, as well as a detail A from FIG. 7a;

FIG. 8a-b a bottom view of the ring binder mechanism in perspective representation as well as detail B from FIG. 8a.

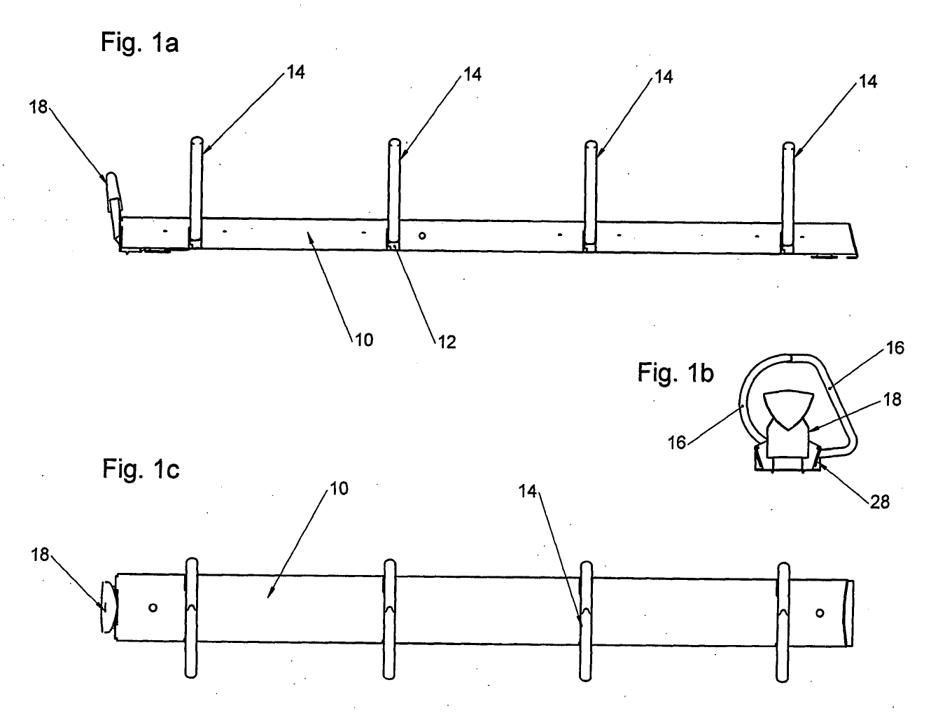

### DETAILED DESCRIPTION OF THE INVENTION

The binder ring mechanisms represented in the drawings are above all intended for receiving loose-leaf, holed sheets, for example, writing material or printed products.

The binder ring mechanism is comprised essentially of a housing, multiple half-rings 16 provided longitudinally spaced from each other and extending through openings 12 in the housing wall 13 and pairwise forming a ring 14 with complementary half-rings, as well as an operating lever 18 for opening and closing the rings. Each of the half-rings 16 of one of the rings 14 is rigidly secured to one of the two carrier rails 20, which on their inward edges—the longitudinal edges facing each other—lie against each other thereby forming a linkage axis 22, and which with their outer edges—the longitudinal edges 24 facing away from each other—engage in inward facing mounting grooves 26 stamped into the housing flanks 28. The carrier rails 20 are introduced into the housing in such a manner, that they can assume two detent positions, one open and one closed. The housing functions as a spring element, which retains the half-rings 16 in their open position and in their closed position. The carrier rails 20 thereby have the function of an elbow lever spring tensioned on the outer edges 24. Therewith, the carrier rails 20 can be limitedly pivoted against each other about their linkage axis 22, taking along the half-rings 16 between the open position and the closed position by overcoming the spring force produced by the bending apart of the housing flanks 28.

In addition, in the illustrative embodiment each ring 14 is provided with a locking element 32 pivotable relative to the housing 10 and to the carrier rails 20, which in the closed position projects into the free space 34 formed between the carrier rails 20 and the housing wall 13 with blocking of the pivot path of the carrier rails 20 and in the open position frees the pivot path about the linkage axes 22. In the illustrative embodiment, each locking element 32 in the form of a pivot element is associated with its own locking spring 36.

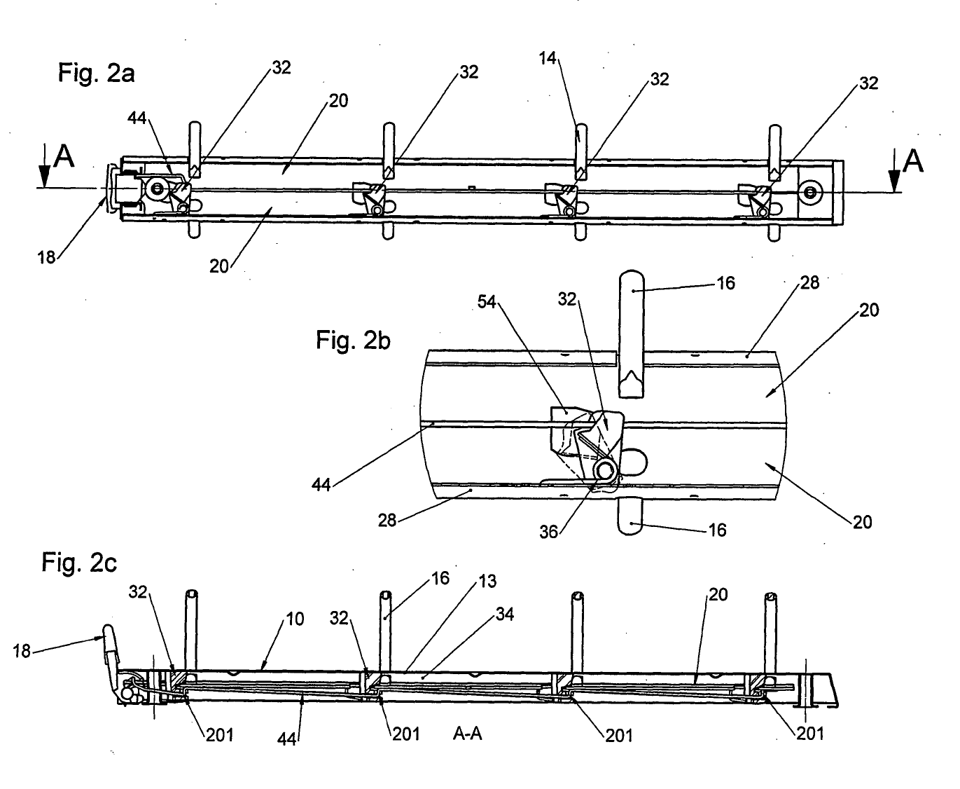

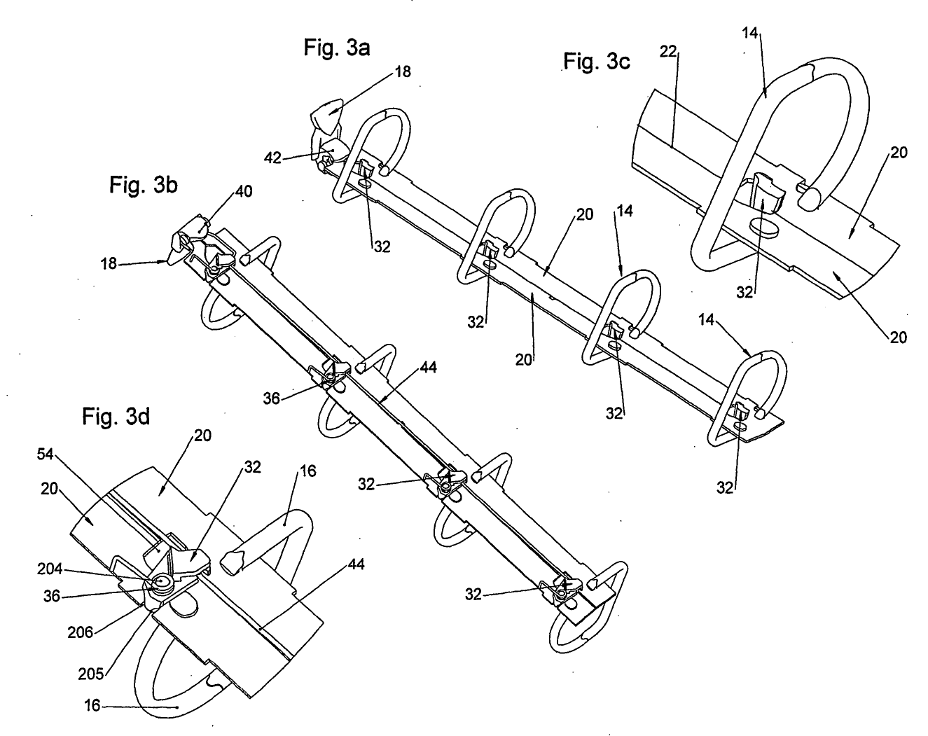

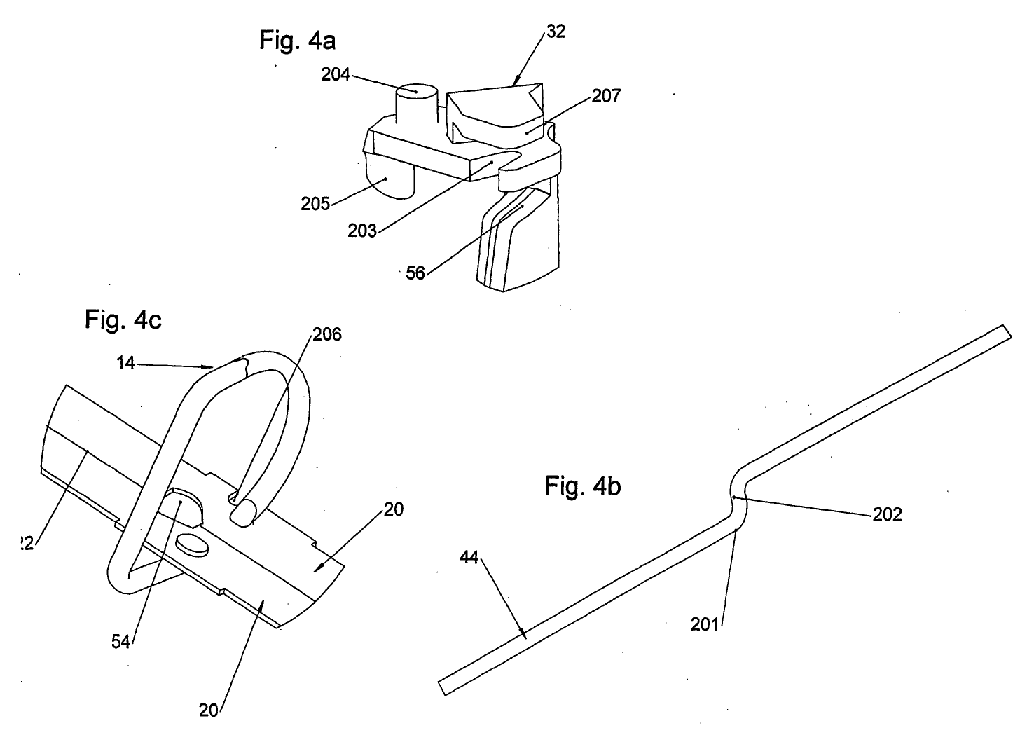

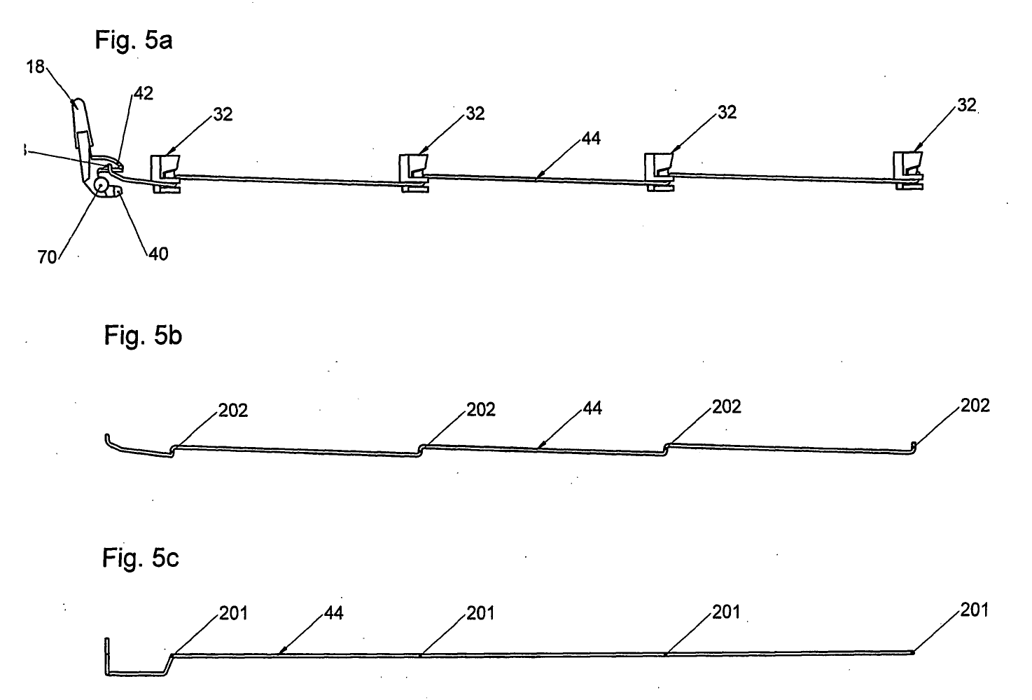

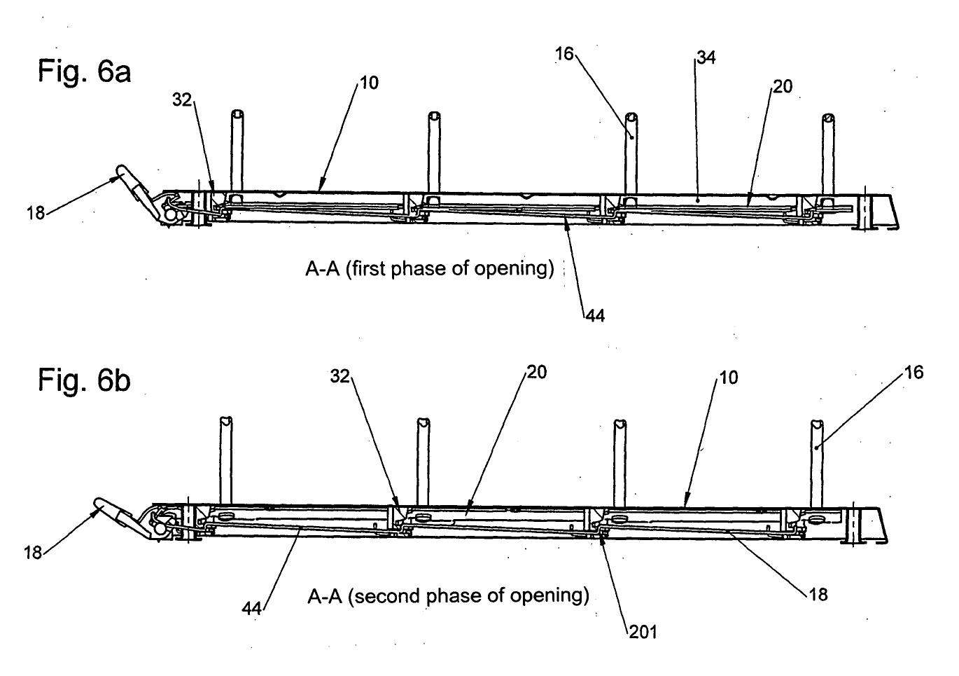

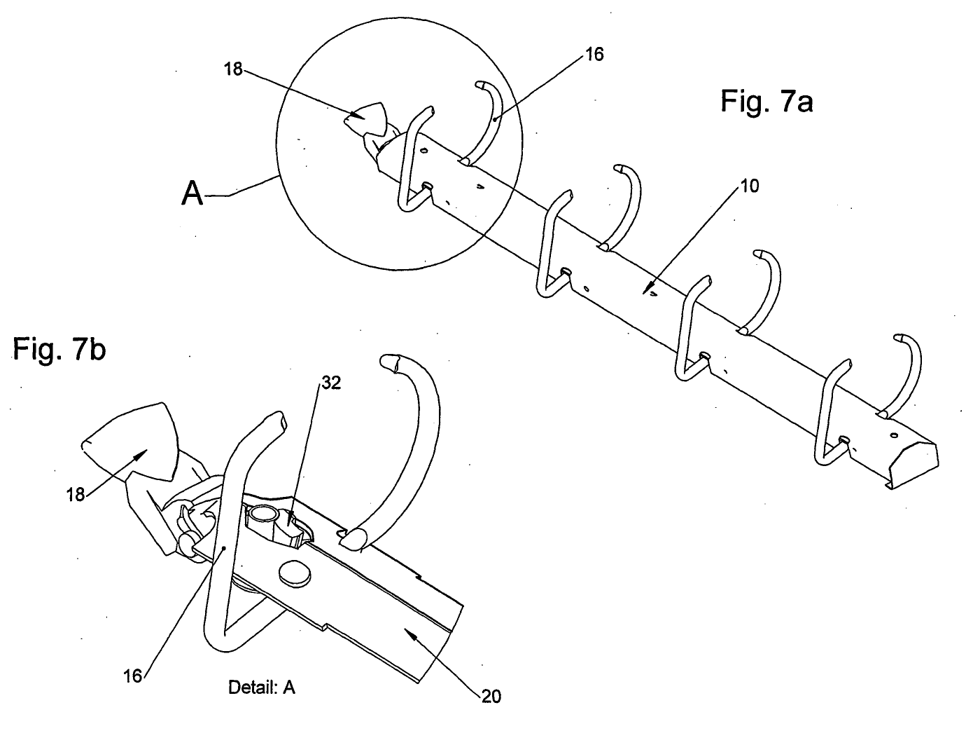

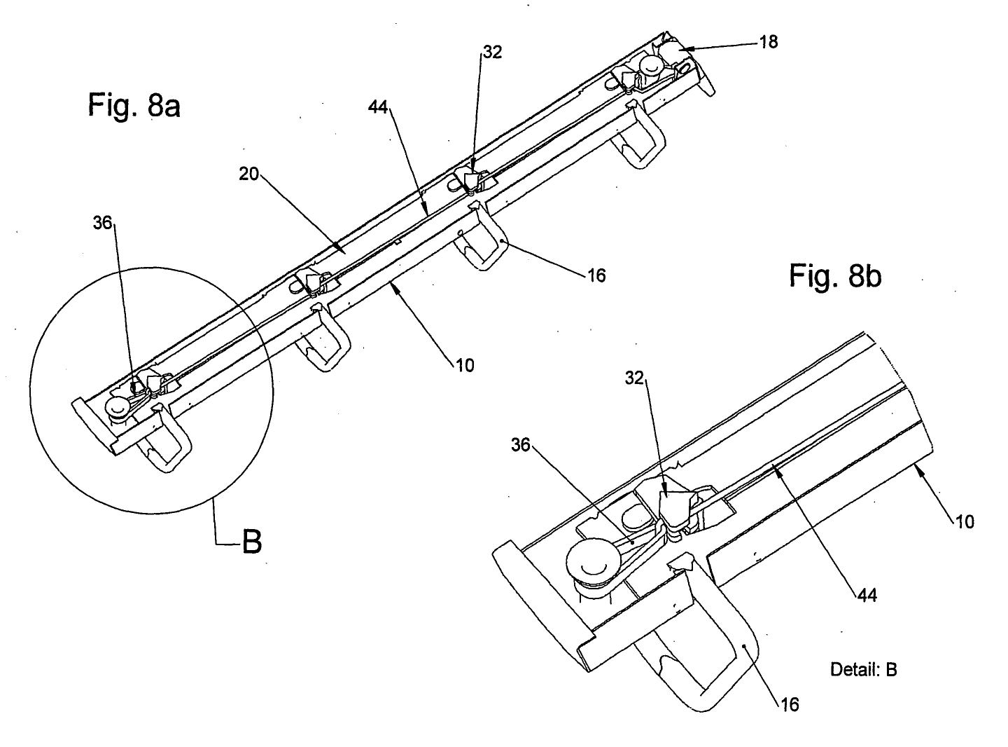

One special feature of the invention is comprised therein, that all locking elements 32 are operated via a common tie rod 44. The tie rod 44, here in the form of a piece of wire, exhibits for this purpose four dogs 201, each of which are respectively associated with one locking element 32. The locking elements 32 in the form of pivot elements are supplementally acted upon in the locking direction by the force of a closing spring 36 (FIGS. 2a and 2b). The closing springs 36 are in the form of leg springs, of which the flanks are supported on the one side against the housing flank 28 and on the other side against the locking element 32 (FIG. 2b). The locking element 32 exhibits for this purpose a spike 204 for the reception of the locking spring 36. In an operating position, the locking element 32 is, besides this, also held pivotably by a projection along the axis 205 in a bearing receptacle 206 on one of the carrier rails 20 (FIGS. 3d and 4a). On the locking element 32, there is further provided a receptacle 203 for the associated dog 102 of the tie rod 44. In the illustrated embodiment the dogs 201 are designed as bends or offsets 202 on the tie rod 44. In order that the dogs 201 are also secured in the transverse direction against sliding out, an abutment plate 207 is formed on the respective locking elements 32 (see FIG. 4a).

The locking elements 32 are pre-tensioned under the influence of the associated locking springs 36 in the direction of the locking position (see FIGS. 3a through 3d). The opening of the rings 14 occurs by displacement or sliding of the tie rod 44 in its longitudinal direction, wherein the actuating lever 18 is depressed. Therein, the locking elements 32 are pivoted against the force of the closing springs 36 about the axis 205 relative to the carrier rails 20 in their open position. The locking element 32 penetrates or extends thereby into the guide through-hole 54 and frees the carrier rails 20 for movement about their pivot axis 22 (represented in dashed lines in FIG. 2b). In the course of the opening process, upon further depressing of the actuating element 18, an opening outrigger or prong 40 formed on the actuating element extends from below against the carrier rails 20 and presses these upwards thereby overcoming the spring force produced by the housing flanks 28, until the carrier rails 20 abut against the housing wall 13. Thereby, the half rings 16 are pivoted in their open position.

During the closing process, the actuating element 18 is pressed upwards. Thereby, the carrier rails 20 are pivoted downwards by the closing outrigger or prong 42 about their linkage axis 22 overcoming the spring force produced by the housing flanks 28 past the locking elements 32, until the free space 34 results. In the last phase of the closing process, the locking elements 32 are displaced under the influence of the closing springs 36 and, with taking along the tie rod 44 and the actuating lever 18, automatically into their locking position (FIGS. 3a through 3d). For further disclosure, in this context, reference is made to the embodiments in WO 01/81099.

The kinematic chain, which is responsible for the release, or as the case may be, the locking of the carrier rails 20, is comprised accordingly of the following elements: actuating element 18, tie rod 44, four locking elements 32 with locking springs 36.

The invention was explained above on the basis of an illustrative embodiment, in which each individual locking element 32 is provided with a locking spring 36. It is basically possible, that the tie rod 44 with its dogs 202, both in the locking direction as well as in the opening direction, is form-fittingly coupled with the locking elements 32 in the form of pivot elements. Thus, there is the possibility that only one locking spring is provided pre-tensioned in the locking direction and engaging against the tie rod 44. Thereby, the expense of assembly associated with the insertion of the locking elements 32 and the locking spring is reduced, without having to accept any functional disadvantages.

The invention further concerns a binder with a ring binder mechanism of the above-described type provided on the spine or back.

1. A ring binder mechanism comprising:
a housing (10) having a C- or U-shaped cross-section with spring-elastic bendable flanks (28),
two carrier rails (20), which carrier rails on their inward facing longitudinal edges lie against each other forming a linkage axis (22) and with their outward facing longitudinal edges (24) engage in mounting grooves (26) in the housing flanks (28), and
with at least two half-rings (16) longitudinally spaced apart from each other and rigidly connected with the carrier rails (20), which half-rings extend through openings (12) in a housing wall (13) and pairwise form a ring (14),
wherein the carrier rails (20) are limitedly pivotable relative to each other about the linkage axis (22) between an open position and a closed position upon overcoming the spring forced produced by the bending open of the housing flanks (28), while taking along the half-rings (16), and
wherein at least two locking elements (32) are provided to be operable via an actuating element (18) and a tie rod (44) which locking elements, in the closed position, protrude into a free space (34) formed between the carrier rails (20) and the housing wall (13) blocking the pivot movement of the carrier rails (20) and, in the open position, free the pivot movement of the carrier rails (20) about the linkage axis (22), wherein the locking elements (32) are pre-tensioned in the direction of the closed position under the influence of a closing spring (36), and wherein the tie rod (44) includes a number of engaging elements, preferably dogs (210), each of which respectively being associated with one of the locking elements (32).

2. The ring binder mechanism according to claim 1, wherein the tie rod (44) is a piece of wire extending essentially parallel to the linkage axis.

3. The ring binder mechanism according to claim 1, wherein the dogs (201) are bends or offsets (202) on the tie rod (44).

4. The ring binder mechanism according to claim 1, wherein each ring element (32) is provided with its own locking spring (36) independent of the tie rod (44).

5. The ring binder mechanism according to claim 4, wherein the locking springs (36) are leg springs.

6. The ring binder mechanism according to claim 1, wherein only one locking spring (36) is provided, namely engaging the end of the tie rod (44) opposite to the actuating element (18).

7. The ring binder mechanism according to claim 1, wherein each locking element (32) includes a receptacle (203) for the corresponding dog (201) of the tie rod (44) and is in operative association therewith.

8. The ring binder mechanism according to claim 1, wherein at least one of the locking elements (32) is a pivot element.

9. The ring binder mechanism according to claim 8, wherein at least one locking element (32) is held pivotably on one of the two carrier rails (20) and/or on the housing (10).

10. A binder with a ring binder mechanism comprising:
a housing (10) having a C- or U-shaped cross-section with spring-elastic bendable flanks (28),
two carrier rails (20), which carrier rails on their inward facing longitudinal edges lie against each other forming a linkage axis (22), their outward facing longitudinal edges (24) engage in mounting grooves (26) in the housing flanks (28),
at least two half-rings (16) longitudinally spaced apart from each other and rigidly connected with the carrier rails (20), which half-rings extend through openings (12) in a housing wall (13) and pairwise form a ring (14),
wherein the carrier rails (20) are limitedly pivotable relative to each other about the linkage axis (22) between an open position and a closed position upon overcoming the spring forced produced by the bending open of the housing flanks (28), while taking along the half-rings (16), and
wherein at least two locking elements (32) are provided to be operable via an actuating element (18) and a tie rod (44) which locking elements, in the closed position, protrude into a free space (34) formed between the carrier rails (20) and the housing wall (13) blocking the pivot movement of the carrier rails (20) and, in the open position, free the pivot movement of the carrier rails (20) about the linkage axis (22), wherein the locking elements (32) are pre-tensioned in the direction of the closed position under the influence of a closing spring (36), and wherein the tie rod (44) includes a number of engaging elements, preferably dogs (210), each of which respectively being associated with one of the locking elements (32).
